(19) United States
(12) Patent Application Publication
(10) Pub. No.: US 2006/0201625 A1
(43) Pub. Date: Sep. 14, 2006

(54) Apparatus for manufacturing semiconductor

(76) Inventor: Jung-Hui Lee, Osan-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/353,042

(22) Filed: Feb. 14, 2006

(30) Foreign Application Priority Data
Mar. 11, 2005 (KR) 2005-0020385

(51) Int. Cl. B08B 6/00; C23F 1/00

(52) U.S. Cl. 156/345.31; 134/1.2

(57) ABSTRACT

There is provided an apparatus having first and second RF coils arranged in a dome temp control unit (DTCU) enhanced process chamber to provide effective plasma formation during a main process and dry cleaning process, whereby a dome structure may be completely cleaned during the dry cleaning process.

### BACKGROUND OF THE INVENTION

1. Technical Field

Embodiment of the invention relate to an apparatus adapted to the manufacture of semiconductor devices. More particularly, embodiments of the invention relate to an apparatus for manufacturing semiconductor devices adapted for use in a process chamber including a dome temp control unit (DTCU).

This application claims the benefit of Korean Patent Application No. 2005-0020385, filed Mar. 11, 2005, the disclosure of which is hereby incorporated by reference in its entirety.

2. Discussion of Related Art

Conventional semiconductor manufacturing equipment includes amongst a host of highly specific processing equipment certain process chambers adapted for use in etching operations. Some of these process chambers come equipped with a so-called dome temp control unit (DTCU), which is an auxiliary chamber adapted to maintain the temperature of the etching process chamber at a desired temperature, e.g., something in the order of about 80 □.

Figures (FIGS.) 1 and 2 illustrate a conventional DTCU such as the kind routinely adapted for use with a process chamber containing a decoupled plasma source (DPS). For purposes of this description, the DPS is assumed to have a structure in which the source and bias radio frequency (RF) power elements are independently controlled during the formation of a plasma within the process chamber. The etching process is performed in a high-density vacuum state using the DPS assisted by the DTCU.

The exemplary DTCU uses a heating lamp and circulated air to regulate the temperature within the associated dome. The circulating air is used to cool the dome which may otherwise be overheated by the plasma formed in the process chamber during the etching operation.

FIG. 2 illustrates a cut-away side section of the process equipment shown in FIG. 1. The process equipment includes a lower chamber 10 and an upper chamber 20. An electrostatic chuck 30 adapted to receive and hold a subject wafer to be processed is provided at the lower portion of upper chamber 20. A cathode 40 adapted to supply a bias power voltage to the subject wafer is provided so as to be upwardly and downwardly movable between lower chamber 10 and upper chamber 20.

A gas supply port 21 adapted to supply a source gas required in the plasma formation process is provided to one side of upper chamber 20. An exhaust line 22 connected to a turbo pump 23 is provided to the other side of upper chamber 20 opposite gas supply port 21.

A DTCU chamber 50 is arranged on an upper portion of upper chamber 20 opposite electrostatic chuck 30. Upper chamber 20 comprises an upper transparent dome 60 having a curved shape that extends upward towards DTCU chamber 50.

A plurality of brackets 80 are provided as part of DTCU chamber 50 in close proximity to dome 60. An RF coil 70 serving as a source power supply may be wound around the bracket pair 80.

A lamp assembly 90 usually comprising having a plurality of center-located lamps 91 is arranged over bracket pair 80. A cooling fan assembly 100 is then provided over lamp assembly 90.

The subject wafer to be plasma etched may be loaded in upper chamber 20 and secured to electrostatic chuck 30. Then a source gas is introduced through gas supply port 21 at the same time that a bias power voltage is applied to cathode 40 and a source power voltage applied to RF coil 70. Under these conditions, the source gas is excited as it passes through the electrical field formed between the bias and source voltages to form a plasma (i.e., in the space between the subject wafer and dome 60). Using this plasma, the subject wafer may be etched into a desired pattern using conventional patterning techniques.

During the etching process, a great quantity of charged gas particles are formed within upper chamber 20. Most of these particles are forcibly discharged through exhaust line 22, however, some particles remain within upper chamber 20. These residual particles may cause a polymer like material having strong adsorptive properties at low temperatures to form on dome 60 and other portions of upper chamber 20. To remove this polymer material from dome 60, a dry cleaning process must be performed immediately performing the plasma etching process.

The conventional dry cleaning process is performed by introducing a cleaning gas like oxygen (O2) into the process chamber and simultaneously applying a source power voltage to RF coil 70. Under these conditions, a plasma is generated proximate dome 60 within the process chamber. During the dry cleaning process, the polymer material on dome 60 may be removed by the plasma and extracted from the process chamber through exhaust line 22 under vacuum pressure.

Unless removed from dome 60 by the dry cleaning process, the polymer material may subsequently flake off the dome at high temperatures and contaminate a subject wafer being processed. That is, particles of the polymer material that stably adhere to dome 60 at low temperatures may separate from dome 60 and fall onto the work piece being processed. Such particle contamination has a tendency to dramatically reduce fabrication yield for the semiconductor devices being formed on the subject wafer.

In the conventional process chamber, the removal of the potentially contaminating polymer material from the lateral portions of dome 60 (e.g., the dome portions located over the outer edges of a subject wafer attached to the electrostatic chuck) isn't a real problem. However, this is not the case for the central portion (e.g., the middle portion of the dome over the center of the subject wafer attached to the electrostatic chuck). See the shaded portion of FIG. 3. This anomaly arises because of the nature of RF coil 70 which is arranged over dome 60 on bracket pair 80 located over the lateral portions of dome 60.

### SUMMARY OF THE INVENTION

Embodiments of the invention provide effective cleaning of this dome structure during the dry cleaning process. In this regard, one embodiment of an apparatus adapted to the manufacture of semiconductor devices, comprising; a lower chamber, an upper chamber, an electrostatic chuck arranged between the lower chamber and the upper chamber, and a cathode associated with the electrostatic chuck and adapted to receive a bias power voltage, a dome temp control unit (DTCU) arranged over the upper chamber, a dome arranged over the electrostatic chuck, a plurality of brackets arranged over at least lateral portions of the dome, a first radio frequency (RF) coil adapted to receive a source power voltage during a main process, and wound on the plurality of brackets over the lateral portions of the dome, and a second RF coil arranged over a middle portion of the dome and adapted to receive the source power only during a dry cleaning process performed after the main process.

In one related aspect, the plurality of brackets comprises extended brackets adapted to support both the first and second RF coils. In another related aspect, the plurality of brackets comprises existing brackets adapted to support the first RF coil, and additional brackets adapted to support the second RF coil. In yet another related aspect, the plurality of brackets comprises existing brackets adapted to support the first RF coil, and the apparatus further comprises; a supporting unit connected between respective inner ends of the existing brackets and adapted to support the second RF coil.

The second RF coil may be formed in a spiral shape within any of these aspects.

### BRIEF DESCRIPTION OF THE DRAWINGS

The above and other features and advantages of the present invention will become more apparent to those of ordinary skill in the art upon consideration of several embodiments of the invention described with reference to the attached drawings in which:

FIG. 1 is an exploded perspective view of a conventional process chamber including a dome temp control unit (DTCU) chamber;

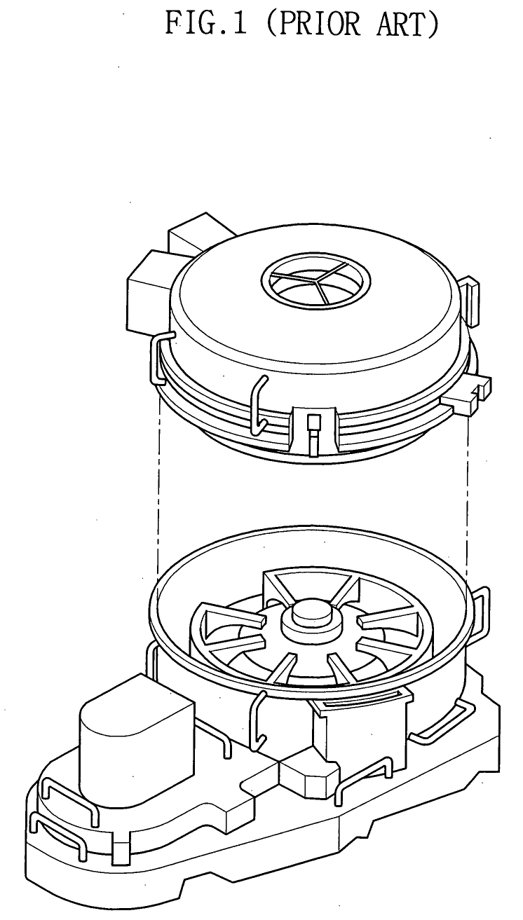

FIG. 2 is a sectional view of the process chamber illustrated in FIG. 1;

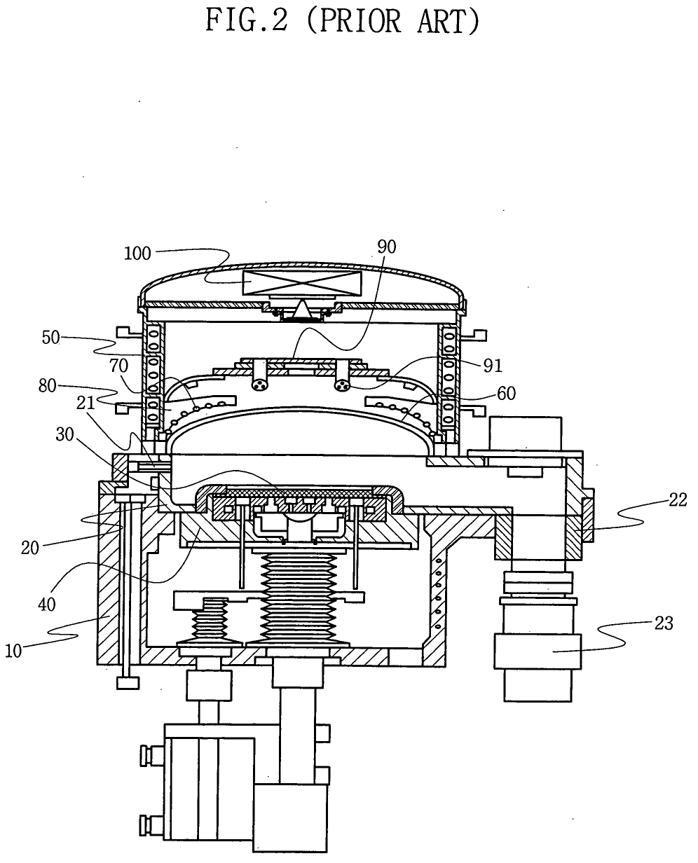

FIG. 3 is another sectional view illustrating plasma formation during dry cleaning of the conventional apparatus of FIGS. 1 and 2;

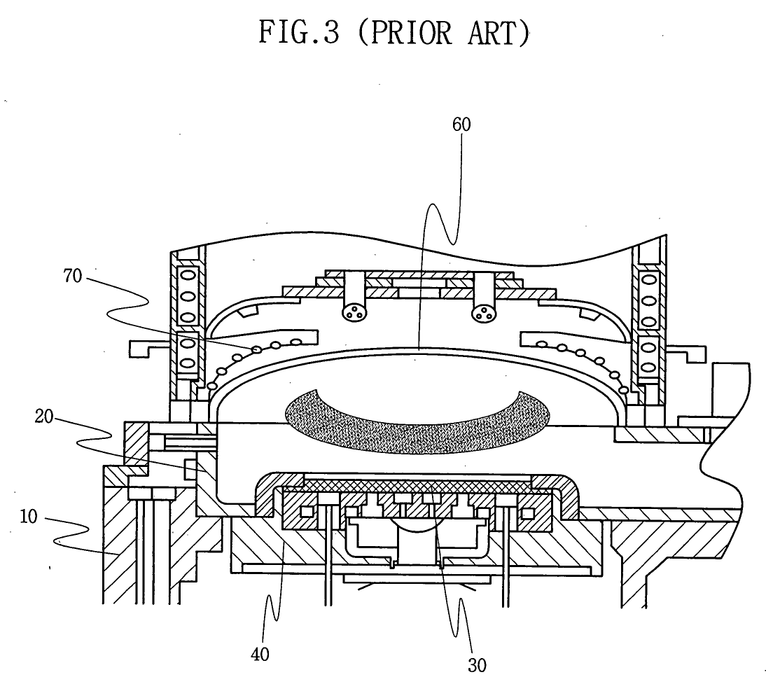

FIG. 4 is a sectional of a process chamber adapted to the manufacture of semiconductor devices according to an embodiment of the invention;

FIG. 5 is a sectional of a process chamber adapted to the manufacture of semiconductor devices according to another embodiment of the invention; and

FIG. 6 is a sectional view illustrating plasma formation during a dry cleaning process in an apparatus adapted to the manufacture of semiconductor devices according to an embodiment of the present invention.

### DESCRIPTION OF EXEMPLARY EMBODIMENTS

Embodiments of the invention relate to an apparatus, such as a process chamber, adapted to the manufacture of semiconductor devices. According to one embodiment of the invention, an apparatus is provided that comprises a lower chamber, an upper chamber, and a dome temp control unit (DTCU). Additionally, an electrostatic chuck adapted to receive and secure a subject wafer to be processed is provided between the lower and upper chambers. A cathode may be arranged in combination with the electrostatic chuck to provide a bias power voltage. In one embodiment, the upper chamber comprises a dome structure arranged between the upper chamber and the DTCU.

One or more gas supply port(s) adapted to introduce a source gas into the process chamber may be arranged to one side of the lower chamber and/or the upper chamber. An exhaust line connected to a turbo pump and adapted to exhaust reactive byproducts from the process chamber may be arranged to the other side of the lower chamber.

The DTCU may be isolated from the upper chamber and the dome, which serve primarily to contain a developed plasma used, for example, in etching processes. This plasma is contained in a region over the subject wafer being processed in the chamber as it is exposed on an upper surface of the electrostatic chuck. Thus, in one embodiment, a plasma reaction chamber is formed in the upper chamber which in turn is covered by a separated DTCU.

A plurality of brackets may be radially arranged over the upper part of the dome under the DTCU, and an RF coil connected to a source power voltage may be associated (e.g., wound on) the brackets. A lamp assembly and a cooling fan assembly adapted to maintain the dome at a desired temperature may be arranged over the brackets.

Within this arrangement, a source gas required for the process being performed in the process chamber, as well as a cleaning and/or purge gas required for the dry cleaning and purging of the chamber may be introduced through the one or more gas supply ports.

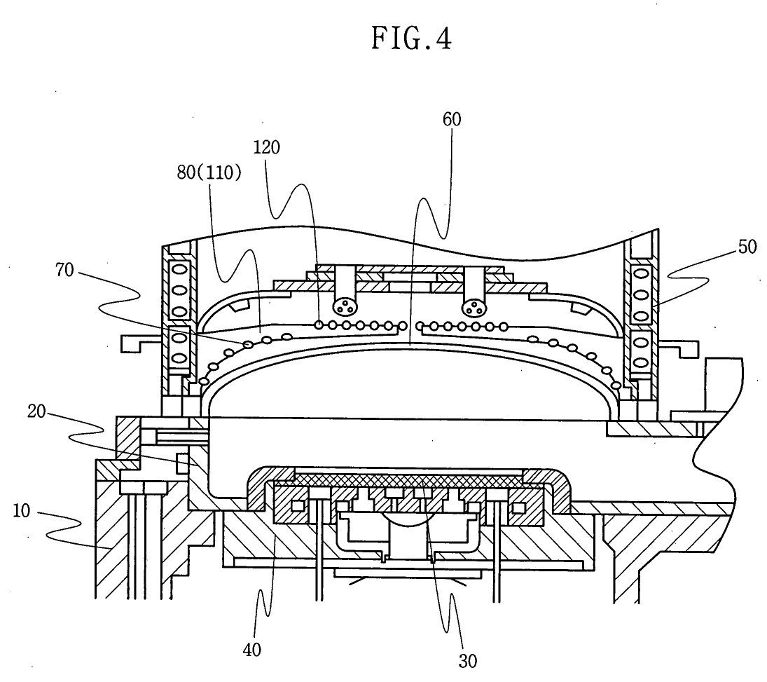

FIG. 4 illustrates an apparatus adapted to the manufacture of semiconductor devices according to an embodiment of the present invention.

As shown in FIG. 4, the apparatus comprises a first RF coil 70 and a second RF coil 120. Second RF coil 120 is specifically arranged over the middle portion of dome 60 and is only used during the dry cleaning process. During the dry cleaning process, a source power voltage is applied to both the first RF coil 70 and second RF coil 120 to faithfully remove any potentially contaminating polymer material from the entire expanse of dome 60. In this regard another source power voltage may be provided, if necessary, to operate second RF coil 120. Extended brackets 110 may be provided in the alternative or in the addition to conventional brackets 80.

Thus, in one embodiment, second RF coil 120 may be formed in a spiral shape where one end of second RF coil 120 is positioned over the center of a subject wafer secured to electrostatic chuck 30. Second RF coil 120 then extends outwardly from this center position over the center portion of dome 60.

Further, as shown in FIG. 4, by using multiple brackets radially arranged to support both the first RF coil 70 and second RF coil 120, the second RF coil 120 may be firmly supported in its extended position over the middle portion of dome 60.

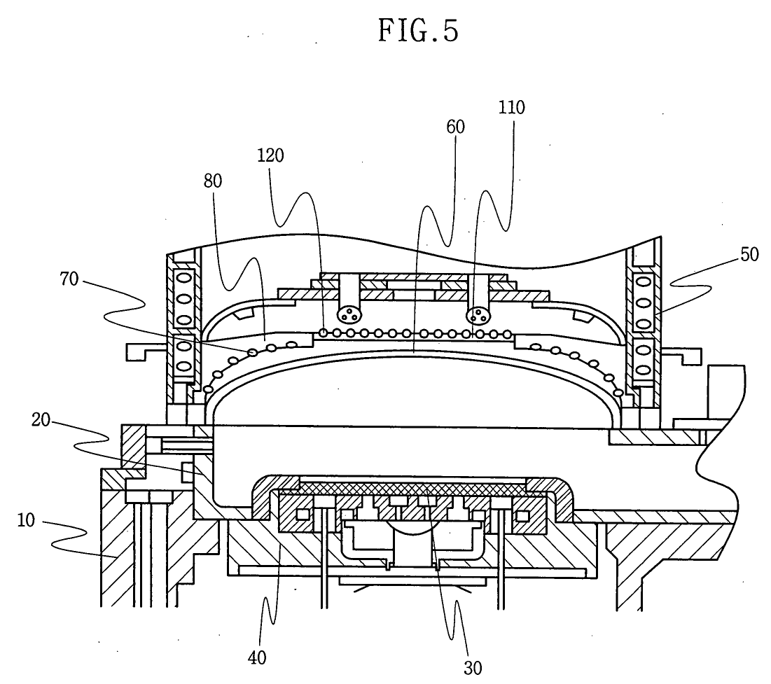

FIG. 5 is a section view illustrating an apparatus adapted to the manufacture of semiconductor devices according to another embodiment of the present invention.

As shown in FIG. 5, the inner ends of (first) brackets 80 are connected with one another by a supporting unit 110. Second RF coil 120 may be wound on supporting unit 110 to position it over the center portion of dome 60. In this manner, either an extended bracket adapted to support both first and second RF coils may be provided, or a conventional process chamber having an existing set of brackets may be modified to provide a similar function.

The operation of an apparatus adapted to the manufacture of semiconductor devices according to an embodiment of the invention will be described.

Once a subject wafer has been secured to electrostatic chuck 30, a bias voltage has been applied thereto via cathode 30, and RF coil 70 receive a source power voltage, a source gas is introduced to one side of upper chamber 20. The source gas forms a plasma in the electric field developed between the subject wafer and RF coil 70. Using this plasma, a main process (e.g., an etching process) is performed on the subject wafer.

Upon completion of the main process, a dry cleaning process is performed. During the dry cleaning process, a bias power voltage is again applied to cathode 40 and the source power voltage is applied to RF coil 70 wound on brackets 80. Additionally at this time, second RF coil 120 wound on supporting unit 100 also receive a source power voltage, such that the cleaning gas supplied to the process chamber between electrostatic chuck 30 and dome 60 is uniformly excited in a plasma.

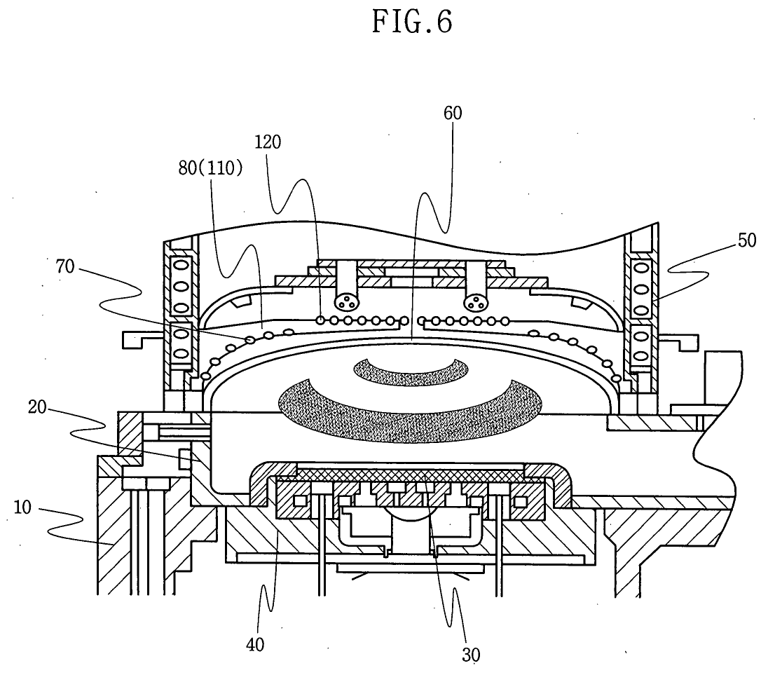

FIG. 6 is a sectional view illustrating plasma formation during the dry cleaning process within an apparatus adapted to the manufacture of semiconductor devices according to embodiments of the invention.

As shown in FIG. 6, when the source power voltage is simultaneously applied to first RF coil 70 and second RF coil 120, the resulting plasma is sufficiently formed over the entirety of electrostatic chuck 30 in a lower part of dome 60. (See, shaded areas).

Any polymer material adhering to the underside of dome 60 is effectively removed by the combination of first RF coil 70 arranged over the lateral portions of dome 60 and second RF coil 120 arranged over the middle portion of dome 60. Consequently, dome 60 is uniformly cleaned by the plasma excited by first RF coil 70 and second RF coil 120.

As the efficiency of cleaning is enhanced, it is possible to prevent the build up (and subsequent flaking) of polymer material. The quality and yield of the semiconductor devices being fabricated on the subject wafer are enhanced accordingly.

The present invention had been described with reference to several exemplary embodiments. However, it is to be understood that the scope of the invention is not limited to only the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. An apparatus adapted to the manufacture of semiconductor devices, comprising:
a lower chamber;
an upper chamber;
an electrostatic chuck arranged between the lower chamber and the upper chamber, and a cathode associated with the electrostatic chuck and adapted to receive a bias power voltage;
a dome temp control unit (DTCU) arranged over the upper chamber;
a dome arranged over the electrostatic chuck;
a plurality of brackets arranged over at least lateral portions of the dome;
a first radio frequency (RF) coil adapted to receive a source power voltage during a main process, and wound on the plurality of brackets over the lateral portions of the dome; and
a second RF coil arranged over a middle portion of the dome and adapted to receive the source power only during a dry cleaning process performed after the main process.

2. The apparatus of claim 1, wherein the plurality of brackets comprises extended brackets adapted to support both the first and second RF coils.

3. The apparatus of claim 1, wherein the plurality of brackets comprises existing brackets adapted to support the first RF coil, and additional brackets adapted to support the second RF coil.

4. The apparatus of claim 1, wherein the plurality of brackets comprises existing brackets adapted to support the first RF coil, and the apparatus further comprises; a supporting unit connected between respective inner ends of the existing brackets and adapted to support the second RF coil.

5. The apparatus of claim 1, wherein the second RF coil is formed in a spiral shape over the middle portion of the dome.

6. The apparatus of claim 2, wherein the second RF coil is formed in a spiral shape on the extended brackets.

7. The apparatus of claim 3, wherein the second RF coil is formed in a spiral shape on the additional brackets.

8. The apparatus of claim 4, wherein the second RF coil is formed in a spiral shape on the supporting unit.

9. The apparatus of claim 1, further comprising a source power voltage source connected to both the first RF coil and the second RF coil.

10. The apparatus of claim 1, further comprising a first source power voltage source connected to the first RF coil and operated during the main process, and a second source power voltage source connected to the second RF coil and operated during the main process and the dry cleaning process.
